(19) United States
(12) Patent Application Publication
(10) Pub. No.: US 2024/0214314 A1
(43) Pub. Date: Jun. 27, 2024

(54) Data Duplication

(71) Applicant: Nokia Technologies Oy, Espoo (FI)

(72) Inventors: Qiyang Zhao, Antony (FR); Teemu Mikael VEIJALAINEN, Helsinki (FI); Stefano PARIS, Vanves (FR)

(21) Appl. No.: 18/555,994

(22) PCT Filed: Apr. 13, 2022
(86) PCT No.: PCT/EP2022/059895

§ 371 Date: Oct. 18, 2023

(30) Foreign Application Priority Data
Apr. 19, 2021 (FI) 20215459

(51) Int. Cl. H04L 47/127; H04L 47/20; H04W 24/02

(52) U.S. Cl. CPC H04L 47/127; H04L 47/20; H04W 24/02

(57) ABSTRACT

A method for optimizing a predictive model for a group of nodes in a communications network includes receiving a tuples of data values, each tuple including state data representative of a state of a node, an action including a specification of paths for duplicating data packets from the node to a further node, and reward data that indicates a quality of service at the node subsequent to duplicating data packets through the paths specified by the action, determining a data value indicative of a performance level for the communications network on the basis of reward data of the tuples, evaluating a predictive model that outputs a set of data values for each node, the data values predicting a quality of service from duplicating data packets on the paths, and modifying the predictive model based on the predicted data values and the data value indicative of a performance level for the communications network.

### TECHNICAL FIELD

The present disclosure relates to a system and method for duplicating data in a communications network.

### BACKGROUND

In recent years, machine learning methods have been deployed in communication networks to improve network performance and automate network management. Standardisation for architectures and pipelines have been proposed to support the integration of machine learning in, for example, Fifth Generation (5G) communication networks.

A machine learning agent may be deployed in the Core Network (CN) to enhance the network performance. The agent collects radio data and network data from Network Element Functions (NEFs) and Operation, Administration and Maintenance (OAM) procedures. This data is used to optimize a machine learning model.

In the Radio Access Network (RAN), Radio Resource Management (RRM) applications may require decisions at milliseconds levels. In this case, training and inferring using machine learning agents outside of the RAN may incur unacceptable delays. Moreover, signalling of radio measurement data, model parameters and decisions may add significant loads on RAN interfaces where radio resources are limited.

To address this, nodes in the RAN including User Equipment (UEs) and Next generation Node B (gNBs) may implement machine learning agents locally to maximize cumulative performance. In particular, a RAN Intelligent Control (RIC) entity may perform training and inference using reinforcement learning at a node. The RIC entity may perform online reinforcement learning tasks, that collect information from nodes and provide decisions.

### SUMMARY

It is an object of the invention to provide a method and apparatus for duplicating data in a communications network.

The foregoing and other objects are achieved by the features of the independent claims. Further implementation forms are apparent from the dependent claims, the description and the figures.

According to a first aspect, a method for optimizing a predictive model for a group of nodes in a communications network is provided. The method comprises receiving a plurality of tuples of data values, each tuple comprising state data representative of a state of a node in the group of nodes, an action comprising a specification of one or more paths for duplicating data packets from the node to a further node of the communications network and reward data that indicates a quality of service at the node subsequent to duplicating data packets through the one or more paths specified by the action. The method comprises determining a data value indicative of a performance level for the communications network on the basis of reward data of the tuples, evaluating a predictive model that outputs a set of data values for each node in the group of nodes, the set of data values predicting a quality of service from duplicating data packets on the one or more and modifying the predictive model based on the predicted data values and the data value indicative of a performance level for the communications network.

In a first implementation form the method comprises, at a node in the group of nodes determining a state of the node, evaluating a policy to determine an action to perform at the node on the basis of the state, the action specifying one or more paths for duplicating a data packet from the node to a further node of the communications network, duplicating the data packet according to the action to the further node, determining reward data representative of a quality of service at the node and communicating a tuple from the node to the network entity, the tuple comprising state data representative of the state, the action and the reward data.

In a second implementation form the method comprises evaluating the predictive model to determine modified reward data for the node and communicating the modified reward data to the node.

In a third implementation form the method comprises receiving the modified reward data at the node and optimizing the policy based on the modified reward data.

In a fourth implementation form the method comprises determining a state of the node, evaluating the optimized policy to determine a further action to perform at the node on the basis of the state, the further action specifying one or more paths for duplicating a data packet from the node to a further node of the communications network and duplicating the data packet according to the further action.

In a fifth implementation form the method comprises receiving, at the node, a further action from the network entity, the further action specifying one or more paths for duplicating a data packet from the node to a further node of the communications network and duplicating one or more data packets to a further node based on the further action.

In a sixth implementation form evaluating the predictive model comprises evaluating a loss function of the data values generated according to the predictive model and the reward data.

According to a second aspect, a network entity for a communications network is provided. The network entity comprises a processor and a memory storing computer readable instructions that when implemented on the processor cause the processor to perform the method according to the first aspect.

According to a third aspect a node for a communications network is provided. The node comprises a processor and a memory storing instructions that when implemented on the processor cause the processor to determine a state of the node, evaluate a policy to determine an action to perform at the node on the basis of the state, the action specifying one or more paths for duplicating a data packet from the node to a further node of the communications network, duplicate the data packet according to the action, determine reward data representative of a quality of service at the node and communicate a tuple from the node to a network entity, the tuple comprising state data representative of the state, the action and the reward data.

These and other aspects of the invention will be apparent from and the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a schematic diagram of a network, according to an example.

FIG. 2 shows a flow diagram of a method for optimizing a predictive model, according to an example.

FIG. 3 is a block diagram showing a predictive model, according to an example.

FIG. 4 is shows a flow diagram of a method for controlling a network, according to an example.

FIG. 5 is a flow diagram shows a flow diagram of a method for controlling a network, according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms including technical and scientific terms used herein are to be interpreted as is customary in the art. It will be further understood that terms in common usage should also be interpreted as is customary in the relevant art and not in an idealized or overly formal sense unless expressly so defined herein.

In Fifth Generation (5G) communication networks, packet duplication allows data packets to be transmitted simultaneously to multiple paths or ‘legs’ through the network to increase the throughput of the network. Duplicating the same packet to different legs can also reduce the packet error probability and latency. The Packet Data Convergence Protocol (PDCP) provides multi-connectivity that permits a UE to connect with up to four legs, including two gNBs and two Component Carriers (CC) when integrated with Carrier Aggregation (CA).

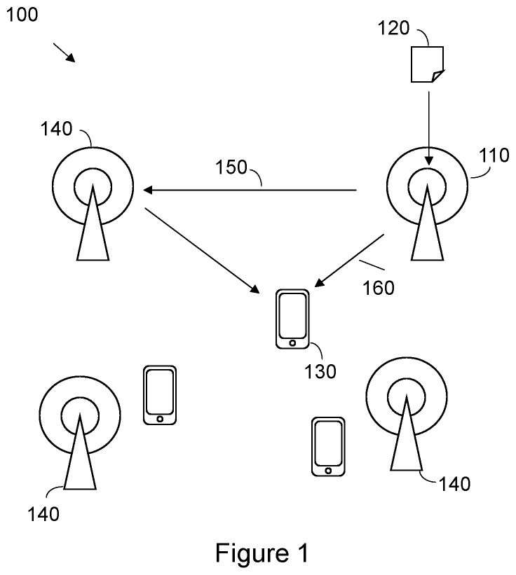

FIG. 1 is a simplified schematic diagram showing a network 100, according to an example. In FIG. 1 a Master gNB (MgNB) 110 receives data packets 120 from the Core Network (CN) and passes them to the hosted PDCP layer that controls the duplication of data packets. The MgNB 110 also maintains the main Radio Resource Control (RRC) control plane connection and signalling with a UE 130.

The MgNB 110 activates one or more Secondary gNBs (SgNB) 140 to setup dual-connectivity for the UE 130. An Xn interface may be used to connect two gNBs to transfer the PDCP data packets duplicated at the MgNB 110 to the associated RLC entity at an SgNB 140. In FIG. 1 the data packets 120 are duplicated along two paths 150, 160 from the MgNB 110 to the UE 130. The MgNB 110 may also activate more than one secondary cells (SCells) on the SgNBs 140. The RRC control plane messages are transmitted by the MgNB 110, also referred to as Primary Cell (PCell). The configured SCells on both MgNB 110 and SgNB 140 are used to increase bandwidth or exploit spatial diversity to enhance reliability performance.

In general, where a machine learning model is deployed by an agent locally in the RAN, the model is optimized from the data observed or collected by the agent. Sub-optimal performance may occur when multiple agents learn independently without coordination. For example, the capacity of a radio channel is affected by the Signal to Interference plus Noise (SINR) ratio. A UE is best placed to observe its surrounding environment to predict the variation of the received signal. However, an agent that deploys a machine learning model in the UE may duplicate packets, assign radio resources and power greedily for the UE in order to maximize its individual performance, leading to severe interference with other UEs in the network. If every agent acts greedily the entire network performance may be reduced to such an extent that none of the UEs can utilize the resources effectively and achieve the optimal performance.

On the other hand, with a single centralized agent the network can potentially collect data from all the UEs to train a global model. The centralized model learns the interactions between multiple UEs and converges to a decision policy that provides the optimal network level performance. Unfortunately centralized learning in this fashion may also be sub-optimal. The model may use a high dimension of input features to differentiate the complex radio environment of each distributed agent. Furthermore, the large number of possible actions may require a large amount of exploration to find an optimal policy. The large dimension may also lead to a larger number of hyper parameters which then takes more iterations for the model to converge. This can also reduce the network performance.

In the multi-connectivity scenario, duplicating packets to multiple legs can reduce the transmission error probability and latency for an individual UE. This is because the end to end reliability and delay is a joint performance of each individual leg. However, such performance gain depends on the channel quality, traffic load and interference level on the secondary legs. In the situation that secondary legs give no improvement to the end to end performance, PDCP duplication reduces the spectral and power efficiency because the used resources have no contribution to the channel capacity. Furthermore, this can reduce the performances of other UEs, which eventually reduces the network capacity. For example, the duplicated traffic can cause higher packet delay and error probability to the UEs in secondary cells, where fewer UEs can achieve the reliability and latency target in the network.

Machine learning may be applied in the context of duplication to select legs for transmitting duplicated packets with the feedback of joint delay and error probability after transmission. In a multi-agent learning scenario where distributed machine learning models are implemented at each individual UE, the model output converges to the legs best satisfying the delay and reliability target. However, the Quality of Service (QOS) of each leg depends on the received signal, interference level and traffic load, which can change due to the dynamic channel condition, network traffic, and mobility of UEs. This will also change the best leg for duplication. In this context, the distributed machine learning model uses a number of training iterations to identify such environment changes and find the best decision. This may cause the model to be highly unstable. Moreover, a UE cannot observe the transmission behaviour of all other UEs in the network, which may cause the distributed model to select a leg which causes a high amount of interference with other legs.

According to examples described herein, methods and systems are disclosed to effectively coordinate distributed machine learning agents in order to achieve global optimal performance for each UE in interactive wireless scenarios, without increasing the amount of radio measurements, exploration and training time.

The method described herein provides a hierarchical multi-agent reinforcement learning model to learn the interactive behaviour of packet transmission between multiple UEs, and their impact on the network level QoS performance. The model output approaches a joint optimal decision policy on packet duplication for multiple UEs, which minimizes delay and maximizes reliability in the network.

In examples, distributed agents are implemented at the nodes of the network (gNB in the downlink or UE in the uplink). When a packet arrives at the PDCP layer, the model outputs a probability of duplicating the packet to each connected leg, under the condition of radio environment states. The distributed agent at the node measures the QoS performance when the receiver is notified that the packet is delivered or dropped, and computes a reward based on a function that approximates its targeted Qos performance. The reward is used to optimize the distributed model, such that it generates the duplication decision that maximizes a cumulative QoS in the future. The distributed models are independent for each node so that they are optimized according to the nodes individual environment state and performance.

A centralized agent may be implemented in a network entity that connects to multiple gNBs such as the Network Data Analytics Function (NWDAF) in the CN, or the RAN Intelligent Controller. The centralized agent collects the radio environment states, actions and rewards from the distributed agents on a periodical basis. The network trains a model that classifies the level of interactions between UEs which affects other UEs performance (rewards) based on their environment states. For example, the interference level within a group of UEs, or the data load level that increases delay. The network model combines the rewards of the UEs that interact highly with each other, to generate a global reward which represents the network level performance target.

Using the trained model, the centralized agent may calibrate the reward reported from each distributed agent, based on their level of incentive to the output of the global model and send the calibrated reward back to the distributed agent. The distributed agent uses the calibrated reward to optimize the distributed model, such that it increases the probability of selecting an action based on its incentive to the global reward, and vice versa.

Alternatively, the centralized agent may compute the best set of actions for all distributed agents as a vector of actions and communicate each action to the corresponding distributed agent. The distributed agent uses the action received by the network for a certain number of data packets or for a certain amount of time until the network communicates that the distributed agent can use its own distributed model.

With this approach, the UE may converge to an action that approximates its individual QoS target, and also maximize the network level performance.

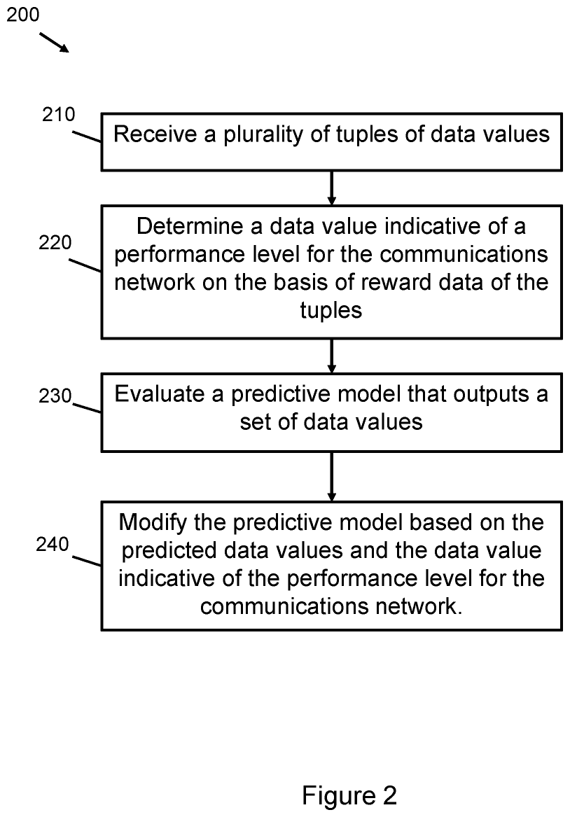

FIG. 2 is a flow diagram of a method 200 for optimizing a predictive model for a group of nodes in a communications network according to an example. The method 200 may be implemented on the network shown in FIG. 1. The method 200 may be used with the other methods and systems described herein. The method 200 may be implemented by a centralized agent such as a RAN Intelligent Controller (RIC).

The method 200 provides global network level optimization of multi-agent learning for UEs with different QoS objectives in an interactive RAN scenario. In particular, in the case of PDCP duplication the method 200 may be used to optimize a model to satisfy each UE's delay, reliability and throughput target and also the network capacity and spectrum efficiency.

The network implements a global model trained from the data reported by all distributed agents, with the objective function of network level performance. The global model is transferred to distributed agents and associated with the UE's connected legs to formulate a distributed model. The distributed agent trains the distributed model from a calibrated function of the network predicted and local observed rewards. To this end, the distributed agent can make duplication decision that has both improvement to its individual and global delay, reliability performance.

At block 210, the method 200 comprises receiving a plurality of tuples of data values. According to examples, each tuple of the plurality of tuples comprises state data representative of a state of a node in the group of nodes, an action comprising a specification of one or more paths for duplicating data packets from the node to a further node of the communications network and reward data that indicates a quality of service at the node subsequent to duplicating data packets through the one or more paths specified by the action.

At block 220, the method comprises determining a data value indicative of a performance level for the communications network on the basis of reward data of the tuples. At block 230, the method comprises evaluating a predictive model that outputs a set of data values for each node in the group of nodes, the set of data values predicting a quality of service for each of the one or more paths from a node in the group of nodes to a further node. At block 240, the predictive model is modified based on the predicted data values and the data value indicative of the performance level for the communications network.

According to a first example of the method 200, the global model is used to learn the influence of multiple UE interactive actions on the network performance based on their correlations of reported states and rewards.

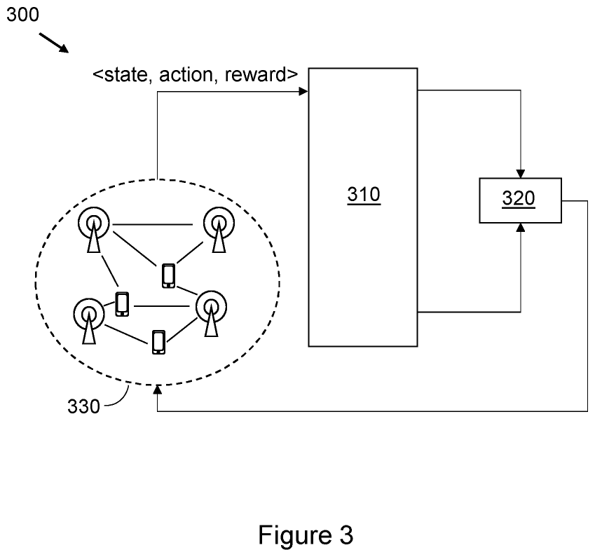

FIG. 3 shows a diagram 300 of a global neural network model with clustered actions, according to an example. In the network side, a global model 310 is implemented in the NWDAF or RIC. The model 310 takes input data over each packet transmission, including the radio measurements of RSRP, buffered load, gNB location (axis), signal Direction of Arrival (DoA) to the served antenna beam. These input data entries can be a sequence over several TTIs in the past. The model uses a set of parameters (i.e. in a neural network) to estimate a set of values representing the qualities of transmitting a packet to the corresponding cell, as indicated in the input. A reward function is defined as a QoS objective for the network, i.e. a function of delay and error probability. The NWDAF or RIC computes a reward for connected legs based on the reward function and updates the model parameters 320 to minimize the loss between the predicted values and rewards. The input data and rewards are collected from all the distributed agents in the network 330.

With the global model implemented, the centralized agent executes the following: the centralized agent initializes a global model with parameters θ_{g}, that takes the input of radio states s (RSRP, buffered bytes, gNB axis, antenna DoA) over multiple legs between gNB and UE, and predicted reward values r(s, θ_{g}) of duplicated packet performance (delay, reliability) transmitted over each corresponding leg.

The centralized agent collects a batch of radio states and rewards periodically from all the connected UEs in the network, computes a global reward based on an objective function of the rewards from all UEs, and optimizes the global model parameters θ_{g} based on a loss function of the global reward and the predicted rewards from the radio states over the global model:
a. Global objective function:

$${r}_{{L}_{i}} = {\sum }_{{u}_{j} ∈ u} \frac{{n}_{{u}_{j}}}{{n}_{u}} {r}_{{L}_{i} {u}_{j}} ,$$

(u: UE set, n: sample number)
b. reward function: r_{L}_{ᵢ}ᵤ_{ⱼ}=(p−pₜ)^{a}·e^{-βd-d}^{ₜ}), (p: error probability, d: delay, each UE can have different targeted error probability pₜ and targeted delay dₜ)
c. Optimization of global model:

$${θ}_{g} ← {θ}_{g} - d C , C = \frac{1}{‖ {L}_{i} ‖ ‖ {u}_{j} ‖} {\sum }_{{L}_{i} ∈ L , {u}_{j} ∈ u} ( r ( {s}_{{L}_{{i}^{u} j} ,} {θ}_{g} ) - {r}_{{L}_{i} {u}_{j}} )$$

The centralized agent computes a calibrated reward for each UE, based on a function of predicted reward from global model, and the UE's observed reward, which balances the global and individual objective:

$${\tilde{r}}_{{L}_{i} {u}_{j}} = r ( {s}_{{L}_{i} {u}_{j}} , {θ}_{g} ) - {r}_{{L}_{i} {u}_{j}}$$

The centralized agent sends the calibrated reward \tilde{r}_{L}_{ᵢ}ᵤ_{ⱼ} to each UE to optimize the distributed models.

In the distributed agents, a distributed model is implemented to decide the legs for transmitting duplicated packets. The model has the same architecture as the network's global model, but with different output layers which are associated with the connected legs and which are different for each UE. Once joining the network, the UE applies the parameters from the global model that has been trained previously. The UE measures radio states s (RSRP, buffered bytes, gNB axis, antenna DoA) over multiple legs periodically. When data arrives at the PDCP layer, the UE uses the distributed model to infer probabilities of duplicating the data packet to each leg. After the data packet is received or lost, the UE collects the delay and error probability of transmission at each leg and computes a reward according to the reward function. With a batch of state, action entries, the UE obtains calibrated rewards from the network, and updates its distributed model to approach a balance between global and individual objective.

With the distributed model implemented, the distributed agent at the gNB or UE executes the following steps. Once connected to the network, the distributed agent requests for the model hyperparameters from the network, to initialize a distributed model θ_{d}.

The distributed agent measures the radio states sᵤ_{ⱼ} (RSRP, buffered bytes, gNB axis, antenna DoA), infers probability of transmitting data packets at each leg, computes a reward based on its individual objective of packet delay d and error probability:

$${r}_{{L}_{i} {u}_{j}} = {( p - {p}_{t} )}^{α} \cdot {e}^{- β ( d - {d}_{t} )} ( {p}_{t} , {p}_{d} can be different for each UE )$$

The distributed agent reports a batch of radio states and rewards to the network and receives the corresponding calibrated reward \tilde{r}_{L}_{ᵢ}ᵤ_{ⱼ} which is biased to the global objective. The distributed agent updates the distributed model parameters θ_{d} based on a loss function of the calibrated reward and the predicted duplication probability from the radio states sᵤ_{ⱼ} locally observed by the agent:

$${θ}_{d} ← {θ}_{d} - d C , C = \frac{1}{‖ {L}_{i} ‖} {\sum }_{{L}_{i} ∈ L} log {\tilde{r}}_{{L}_{i} {u}_{j}} p ( {s}_{{L}_{i} {u}_{j} ,} {θ}_{g} )$$

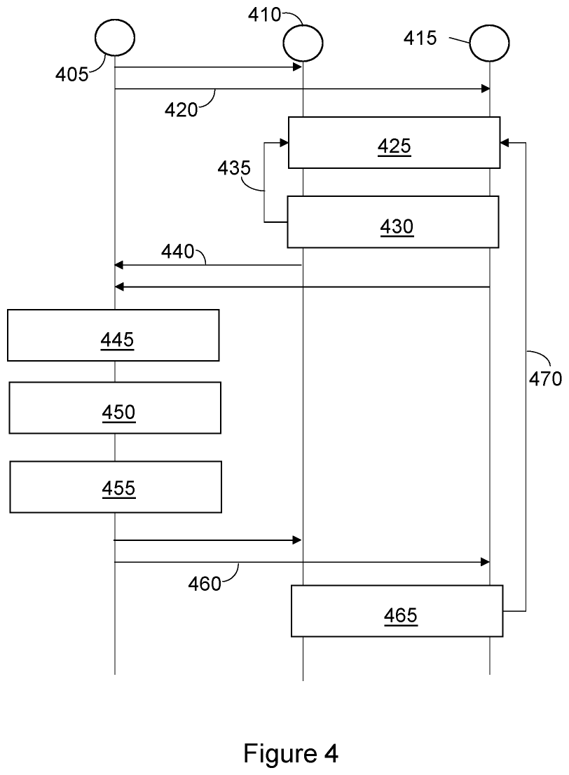

This procedure is shown in the flow diagram in FIG. 4. The node 405 comprises a centralized agent at the NWDAF or RIC. The nodes 410, 415 comprise distributed agents at a gNB and UE, respectively. At 420 the centralized agent 405 communicates hyperparameters to initialize the distributed model at 410, 415. At 425 radio states are measured to predict the duplication probability on each leg based on the distributed model. At 430 the local reward based on the data packet delay and error is determined for an individual target. This is repeated at 435, to generate a batch of states and rewards.

At 440 the batches of observed states and rewards are reported to the centralized agent 405. At 445 a global reward is computed based on functions of rewards from all the UEs. At 450 global parameters are optimized based on the loss of global and predicted rewards from the reported states. At 455 a calibrated reward is computed for each UE based on the function of the global predicted reward and individual UE reward. At 640, the calibrated rewards are assigned to each corresponding agent. At 465, the distributed parameters are optimized based on a loss of the calibrated rewards and UE predicted rewards. At 470 the process may be repeated using the optimised distributed parameters in the next iteration.

In a second example, the global model is used to directly predict the optimal policy for each distributed agent in the network. The model is trained to learn the interactive influences between multiple UEs by exploring through a combinatorial action space.

The global reward computed by the centralized agent is the sum of the individual rewards computed by the distributed agents. Let aᵢ ∈ A be the action selected by UE i ∈ {1, . . . , N}, then the system reward Xₐ_{₁}ₐ_{₂}_{. . . a}_{ₙ} obtained by the union of all UE actions can be defined as:

$${X}_{{a}_{1} {a}_{2} … {a}_{n}} = {\sum }_{i = 1}^{N} {X}_{{a}_{i}}$$

According to examples, three types of decision policies may be defined:
A Phase Decision Agent, π₀, which is executed by the central agent that decides the exploration/exploitation phase.
A Global Decision Agent, π_{g} which is executed by the central agent selects the set of actions that maximize the global reward.
A Local Decision Agent, πₜ which is executed by the distributed agent selects the independent action/arm that maximizes its own local reward.

At each iteration, the central agent uses policy π₀ to determine whether to explore via the Local Decision Agents or exploit via the Global Decision Agent:
If exploration was selected: N feasible actions are selected individually by Local Decision Agents using the policy πᵢ. Therefore, the decision policy πₜ is executed N independent times to select a value for each UE. The set of actions obtained by combining all N independent actions is added to the Global Decision Agent.
If exploitation was selected: a set of actions is selected by using the policy π_{g} over all sets of actions already stored in the Global Decision Agent.

According to examples, each policy implementing an agent may be parametrized by for example an error probability & that defines the sampling of the action space. The Phase Decision Agent has only two actions (exploration and exploitation), each Local Decision Agent has K actions—duplication and no-duplication for PDCP duplication, while the set of actions of the Global Decision Agent is a subset of all possible KN actions obtained by combining all possible actions of the distributed agents.

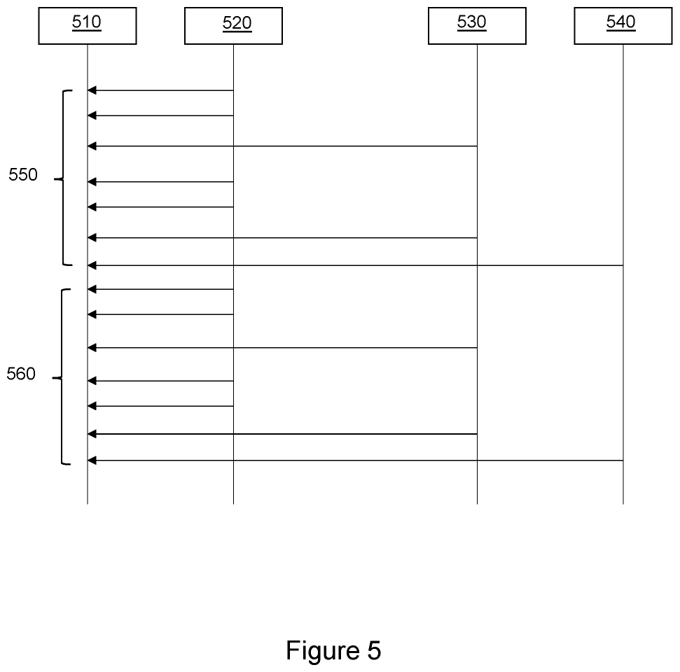

FIG. 5 shows a flow diagram 500 of transmissions and communication among the central agent 510 and the distributed agents 520, 530, 540 during exploitation and exploration phases decided by the Phase Decision Agent. Each iteration 550, 560 starts with the Phase Decision Agent that decides between exploration and exploitation and terminates when at least one action-reward sample is collected from all Local Decision Agent/UEs 520, 530, 540.

During the exploration phase 550 the Local Decision Agents 520, 530, 540 decide actions autonomously. For example, Local Decision Agent 520 may select action 0 (i.e., no-duplication) then action 1 (i.e., duplication) alternatively. Once the Central Agent 510 has collected at least one action-reward from all UEs, it uses the Phase Decision Agent to decide the next phase 560 and triggers the Global Decision Agent to compute the best set of actions according to the policy π_{g}. The best set of actions computed by the Global Decision Agent is used to dictate the actions of the Local Decision Agents 520, 530, 540.

The single actions of the set of actions are communicated to the Local Decision Agents that in turn execute them. The same action is repeated by a Local Decision Agent until a new action is communicated by the Global Decision Agent, which is executed by Central Agent. The duration of each phase depends on the slowest UE. If actions are taken on a per-packet base (i.e., the decision is applied to each packet), the UE with the lowest traffic data rate will determine the duration of each phase.

According to examples, the policies implemented by the Phase Decision Agent may be implemented for example using random or Boltzmann sampling techniques, whereas the Global and Local Decision Agents may be implemented using the upper confidence bound technique of multi armed bandits.

The methods and systems described herein improve network level performance. The global objective function of aggregated rewards from all UEs enables the global model to learn the impact of packet duplication between UEs (i.e. traffic congestion, interference) without introducing measurements, to predict the network level QoS of duplicating packets to each leg. This avoids in fully distributed learning a UE duplicating packets with harmful impact to others, which finally reduces performance for all UEs.

Furthermore the methods described support different KPI targets of UEs. The UE combines its locally observed reward with the network predicted reward to train its duplication decision model. This allows the UEs to have different QoS target in the objective function. For example, the eMBB and URLLC services have different throughput and reliability requirement. Positive rewards are given to a leg that both satisfies UE's individual target and improves network level performance.

The methods and systems support UEs in different scenarios. The global model assists the distributed model to learn influence from adjacent UEs, rather than replacing their policies. This allows the UEs to use the distributed model to make decisions that avoid interference with others in an area where the global model is not available or converged. The trained distributed models from multiple agents also assist the global model to converge faster and reduce the need for exploring all possible combinatorial actions from all the UEs in the network.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

The present inventions can be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. A method for optimizing a predictive model for a group of nodes in a communications network, the method comprising:
receiving a plurality of tuples of data values, a tuple comprising:
state data representative of a state of a node in the group of nodes;
an action comprising a specification of one or more paths for duplicating data packets from the node to a further node of the communications network; and
reward data that indicates a quality of service at the node subsequent to duplicating data packets through the one or more paths specified with the action;
determining a data value indicative of a performance level for the communications network on the basis of reward data of the tuples;
evaluating a predictive model that outputs a set of data values for the node in the group of nodes, the set of data values predicting a quality of service from duplicating data packets on the one or more paths; and
modifying the predictive model based on the predicted data values and the data value indicative of a performance level for the communications network.

2. The method of claim 1, comprising, at a node in the group of nodes:
determining a state of the node;
evaluating a policy to determine an action to perform at the node on the basis of the state, the action specifying one or more paths for duplicating a data packet from the node to a further node of the communications network;
duplicating the data packet according to the action to the further node;
determining reward data representative of a quality of service at the node; and
communicating a tuple from the node to the network entity, the tuple comprising state data representative of the state, the action and the reward data.

3. The method of claim 1, comprising:
modifying the reward data based on the evaluation of the predictive model for the node; and
communicating the modified reward data to the node.

4. The method of claim 1, comprising receiving the modified reward data at the node and optimizing the policy based on the modified reward data.

5. The method of claim 1, comprising:
determining a state of the node;
evaluating the optimized policy to determine a further action to perform at the node on the basis of the state, the further action specifying one or more paths for duplicating a data packet from the node to a further node of the communications network; and
duplicating the data packet according to the further action.

6. The method of claim 1, comprising:
receiving, at the node, a further action from the network entity, the further action specifying one or more paths for duplicating a data packet from the node to a further node of the communications network; and
duplicating one or more data packets to a further node based on the further action.

7. The method of claim 1, wherein evaluating the predictive model comprises evaluating a loss function of the data values generated according to the predictive model and the reward data.

8. A network entity for a communications network, the network entity comprising:
at least one processor; and
at least one non-transitory memory storing instructions that, when executed with the at least one processor, cause the network entity to perform;
receiving a plurality of tuples of data values, a tuple comprising:
state data representative of a state of a node in the group of nodes;
an action comprising a specification of one or more paths for duplicating data packets from the node to a further node of the communications network; and
reward data that indicates a quality of service at the node subsequent to duplicating data packets through the one or more paths specified with the action;
determining a data value indicative of a performance level for the communications network on the basis of reward data of the tuples;
evaluating a predictive model that outputs a set of data values for the node in the group of nodes, the set of data values predicting a quality of service from duplicating data packets on the one or more paths; and
modifying the predictive model based on the predicted data values and the data value indicative of a performance level for the communications network.

9. A node for a communications network, the node comprising:
at least one processor; and
at least one non-transitory memory storing instructions that, when executed with the at least one processor, cause the node to:
determine a state of the node;
evaluate a policy to determine an action to perform at the node on the basis of the state, the action specifying one or more paths for duplicating a data packet from the node to a further node of the communications network;
duplicate the data packet according to the action;
determine reward data representative of a quality of service at the node; and
communicate a tuple from the node to a network entity, the tuple comprising state data representative of the state, the action, and the reward data.

10. The node of claim 9, wherein the instructions, when executed with the at least one processor, cause the node to:
receive modified reward data from the network entity, the modified reward data being determined on the basis of an evaluation of a predictive model; and
optimize the policy based on the modified reward data.

11. The node of claim 9, wherein the instructions, when executed with the at least one processor, cause the node to:
determine a state of the node;
evaluate the optimized policy to determine a further action to perform at the node on the basis of the state, the further action specifying one or more paths for duplicating a data packet from the node to a further node of the communications network; and
duplicate the data packet to the further node based on the further action.

12. The node of claim 9, wherein the instructions, when executed with the at least one processor, cause the node to:
receive a further action to perform at the node on the basis of the state, the further action specifying one or more paths for duplicating a data packet from the node to a further node of the communications network; and
duplicate one or more data packets to the further node based on the further action.

13. The node of claim 9, wherein the node comprises a user equipment or a next generation node B.

14. A communication network comprising a network entity according to claim 8.

15. A non-transitory program storage device readable with an apparatus, tangibly embodying a program of instructions executable with the apparatus for performing the method of claim 1.
